(19) United States
(12) Patent Application Publication
(10) Pub. No.: US 2023/0267401 A1
(43) Pub. Date: Aug. 24, 2023

(54) METHODS AND SYSTEMS FOR MITIGATING TRANSPORTATION ERRORS

(71) Applicant: EQUIDOOR, LLC, Atlanta, GA (US)

(72) Inventor: Nick MCKAY, Atlanta, GA (US)

(73) Assignee: EQUIDOOR, LLC, Atlanta, GA (US)

(21) Appl. No.: 18/141,813

(22) Filed: May 1, 2023

Related U.S. Application Data
(63) Continuation of application No. PCT/US2021/057870, filed on Nov. 3, 2021.
(60) Provisional application No. 63/111,797, filed on Nov. 10, 2020.

(51) Int. Cl. G06Q 10/083

(52) U.S. Cl. CPC G06Q 10/083

(57) ABSTRACT

Methods and systems for mitigating transportation errors are described herein. A computing device receives a communication from each of a plurality of client devices. Each communication includes a first set of characteristics based on user interaction with a webpage. For each first set of characteristics, the computing device generates a user-object dataset that includes a hierarchy of metrics predictive of a condition of future object acquisitions by a user. The computing device receives a second set of characteristics based on previous instances of object transmissions to an address associated with the user. The computing device modifies the hierarchy of metrics based on the second set of characteristics to generate a modified hierarchy of metrics and executes a trained classifier to generate an error metric that is a prediction indicative of a transporting error being indicated. The computing device stores the error metric in association with the user-object dataset.

### CROSS-REFERENCES TO RELATED APPLICATIONS

The present application is a continuation of International Application No. PCT/US2021/057870, filed on Nov. 3, 2021, which claims the benefit of and the priority to U.S. Provisional Application No. 63/111,797, filed on Nov. 10, 2020, the entire contents of which are herein incorporated by reference in their entireties for all purposes.

### BACKGROUND

A number of entities are involved in the transfer of objects from online object sources and individual users. For example, an online object source may store an object in a physical storage center and/or a third party center. The object may then transferred to a transporter (or a plurality of transporters depending on the destination of the individual user), which may transmit the object to the individual users.

Some users may indicate transporting errors (e.g., that an object was damaged, destroyed, or not received) to the object source or refuse to accept the object (if the object was damaged or destroyed). While sometimes the transporting errors may be legitimate, other times the transporting errors may be generated by a user to take advantage of the object source to obtain a compensation, additional object, a replacement of the object, etc. The false indication may cause the online object source to use already limited resources to correct the error (e.g., processing resources of computing devices and/or computing devices to manage availability of new objects and transport new objects, time to execute the corrective action, resources for transporting and the additional objects, etc.).

### SUMMARY

Aspects of the present disclosure include a method for processing user-object datasets to predict a likelihood of subsequent transporting errors. The method comprises: receiving, by a computing device, a communication from each of a plurality of computing devices, each communication including a first set of characteristics that are based on user interaction with a network document, wherein the first set of characteristics includes: an identification of a user; one or more addresses associated with the user; and one or more instances of an object acquisition; generating, for each first set of characteristics, a user-object dataset that includes a hierarchy of metrics that are predictive of a condition of future object acquisitions by the user associated with the first set of characteristics; and receiving, from a device facilitating a transportation protocol, a second set of characteristics associated with a first user-object dataset, the second set of characteristics being based on previous instances of object transmissions to an address of the one or more addresses associated with the user; modifying the hierarchy of metrics of the first user-object dataset based on the second set of characteristics to generate a modified hierarchy of metrics; executing, using the modified hierarchy of metrics, a trained classifier to generate error metric, the error metric being a prediction indicative of a transporting error being indicated; and storing, in association with the user-object dataset, the error metric.

Another aspect of the present disclosure includes a method for modifying object requests. The method comprises: receiving, by a client device, a communication from a user device that includes an identification of one or more objects, the communication generated based on user interaction with a network document associated with the client device; receiving, by the client device from the user device, a first set of characteristics that correspond to a particular user of the user device retrieving, from a security-monitoring computing device, a user-object dataset associated with at least one characteristic of the first set of characteristics, wherein the user-object dataset stores previous object acquisition information associated with the at least one characteristic; generating an object package using the first set of characteristics and based on the user-object dataset; receiving, based on the object package, an identification of a transportation protocol for transmitting the one or more objects to a particular user of the user device; transmitting, to a security-monitoring computing device associated with a transmitter, an identification of the particular user and the transportation protocol; receiving, from the security-monitoring computing device associated with the transmitter: one or more transmission parameters that are to be included in the transportation protocol; and a second set of characteristics that is based on previous object transmissions that involve at least one characteristic of the first set of characteristics and the transmitter; modifying based on the second set of characteristics the object package; and executing the object package according to the transportation protocol to transmit the one or more objects to the particular user of the user device.

Another aspect of the present disclosure comprises a system comprising one or more processors and a non-transitory computer-readable media that includes instructions that when executed by the one or more processors, cause the one or more processors to perform the methods described above.

Another aspect of the present disclosure comprises a non-transitory computer-readable media that includes instructions that when executed by one or more processors, cause the one or more processors to perform the methods described above.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a block diagram of system for mitigating transportation errors, according to certain aspects of the present disclosure.

FIG. 2 illustrates a flowchart of a process for processing user-object datasets to predict a likelihood of subsequent transporting errors according to aspects of the present disclosure.

FIG. 3 illustrates a block diagram of a process for modifying object requests according to aspects of the present disclosure.

FIG. 4 depicts an example flowchart of a process for generating a response to an object request, according to certain aspects of the present disclosure.

### DETAILED DESCRIPTION

Online object acquisition can be an error-prone process in which an object may be indicated as being damaged, destroyed, stolen, and/or not received. A user may indicate a transporting error (e.g., that an object was damaged, destroyed, or not received) to the object source that originally provided or transported the object or refuse receipt of the acquired object (if the object was damaged or destroyed). Potentially, the object source must take corrective action by sending a replacement object. When an object is indicated as having been received in damaged condition, the object source may request that the user return the damaged object before a replacement object is sent, though this request may tarnish the source-receiver relationship, so some object sources forego such requests. In instances where such damage actually occurred, the cause of the error may be the result of the one or more transporters that transferred the objects to the user. In that instance, the online object source may attempt to recover the lost value from the transporter. In some instances, the transporter may have transported the object successfully, but the user generated a false indicate to receive additional copies of the object or to receive a compensation. The false indicate may cause the online object source to consume already limited resources to correct a false error (e.g., processing resources of client devices and/or security-monitoring computing devices to manage inventories and transport new objects, time to execute the corrective action, resources for transporting the replaced objects, etc.).

Methods and systems are described herein for reducing loss in the transmission of objects to users. A user may request an object (e.g., through a network document, such as a webpage) for transportation to an address (e.g., associated with the user). The request may identify the one or more objects requested and destination information (e.g., a destination address and/or transporting name) and/or user information (e.g., a user name, user address, and the like). A webserver operating the webpage may execute a query to a remote security-monitoring computing device using one or more identifiers of the one or more objects and the user-identifying information for information associated with previous object requests associated with the user and/or destination address. The remote security-monitoring computing device may query and process stored information to generate and return a prediction indicative of whether the user is likely to indicate a transporting error (e.g., an indicate of damaged objects, not received objects, destroyed objects, stolen objects, a request for a return, a request for a replacement, a request for compensation, etc.).

The security-monitoring computing device may access data corresponding to previous object requests associated with multiple different webpages and different requesting users. The security-monitoring computing device may use the information to establish a user-object dataset that corresponds to an individual user. The user-object dataset may include user-identifying information as well as previous-object-request information associated with the individual user. The previous-object-request information may include information associated with a set of discrete requests initiated by the individual user (e.g., with each discrete request being associated with an object order). Each discrete request may have been for one or more objects. The previous-object-request information may indicate request information, such as, for each request: a number of objects being requested, types of objects being requested, value of objects being requested (e.g., a cumulative value or value of one or more individual objects), an address to which the objects were requested to be transported, and/or a time period during which the objects were requested to be transported. The previous-object-request information may indicate result information, such as whether the user asserted that there was a transportation error (e.g., object damage, late object transportation, stolen object, or no object transportation), whether any user-identified error was determined to have been substantiated, and/or whether an object source compensated for any user-identified error (e.g., and how).

An object source, upon a request for an object from a device associated with a user, may send a request to the computing system to provide information characterizing the device and/or the user. The object source may be an entity that provides objects for resources such as, but not limited to a manufacturer, retail entity, or the like. In some instances, the computing system may then access previous transportation information corresponding to a destination address associated with the user (or corresponding to one or more past destination addresses associated with the user). The previous transportation information may be in a data store controlled by and/or accessible to the security-monitoring computing device, and/or the previous transportation information may be accessed by requesting data from one or more other devices.

For example, the security-monitoring computing device may build a data store that includes previous transportation information associated with multiple requestors by receiving, cataloguing and/or process information from computing systems associated with one or more transporting entities, one or more transportation entities, one or more physical object storage centers and/or one or more object sources. The security-monitoring computing device may process the information by (for example) extracting one or more data-field values from each of a set of data entries and indexing information in accordance with the data-field values. The data-field values by which object-transportation information (e.g., previous transportation information) is indexed may include (for example) a name of a requestor, a transportation address, a user address, an email address, a phone number, an Internet Protocol (IP) address, and/or a merchant address.

The data-field values may be processed to generate higher level information associated with (for example) a given user, a given group of users, a given destination address, a given user address, a given user IP address, a given transporting complex address, a given transporting region and/or a given transporting zip code (e.g., a 5-digit zip code, or a 9-digit zip code). The higher level information may include, for example, a quantity of indicated transporting errors (e.g., a raw number, a frequency, or a percentage of orders for which transporting errors were indicated). In some instances, higher level information includes indices that have the potential to be associated with multiple users. Higher level information may then include (for example) a quantity or identification of users that transported to that address or geographical area (e.g., within a given time period) and/or a distribution error-indicate instances across users that transported to that address (e.g., indicating a number, frequency or proportion of error reports associated with each of multiple users associated with the address or area).

As indicated, previous transportation information may be indexed in multiple ways. For example, suppose that a person is living in an apartment with multiple roommates in an apartment building in a given neighborhood. The person may be associated with an identity of the person, an address of the apartment, an address of the apartment building and an address of the neighborhood. In some instances, data stores are configured to generate data records that are individually associated with each of these indices (e.g., potentially resulting in overlapping data storage). In some instances, links between various types of indices are formed (e.g., such that each transportation record may be associated with two or more of a user identification, address identification, building-address identification, an email address, a phone number, an Internet Protocol (IP) address, neighborhood identification, and so on).

In some instances, the security-monitoring computing device may generate a prediction as to a likelihood that a given object request will result in a user-indicated transporting error. For example, the security-monitoring computing device may derive a feature vector that includes a set of features that inform a prediction as to whether a given object request, requesting user, destination address, etc. is likely to result in a subsequent alleged transporting error.

In some instances, one or more rules may be defined to determine how to perform request processing in view of a prediction of a transporting-error likelihood. For example, upon receiving an object request (e.g., order), a webserver may transmit one or more communications to the security-monitoring computing device that indicate one or more identifiers associated with the object request. The communication(s) may correspond to a request for a prediction corresponding to a likelihood that handling of the request would result in a user-indicated transporting error (e.g., indicating that the object was not received, was received in a damaged form or was received late).

The webserver may receive a response from the security-monitoring computing device and, in response, generate a response to the object request. In some instances, a rule may indicate that—if the response predicts that a indicated transporting error is likely (or depending on a degree to which the response predicts that a indicated transporting error is likely)—the webserver is to adjust an object value (e.g., price), processing amount, transporting amount or return policy (e.g., and/or the rule is to specify how such adjustment is to be performed). In some instances, a rule may define how to determine whether a compensation or return policy is to be provided (or what type of compensation or return policy is to be provided) based on the predicted likelihood of an indication of a transporting error. In some instances, a rule may define circumstances under which an object is to be transported to an alternative location (e.g., different than a destination address entered by a user) based on the predicted likelihood of an indication of a transporting error. For example, a rule may indicate circumstances under which an object is to be transported to a P.O. address. In some instances, a rule may define circumstances under which an object is to be transported with a transporting precaution, such as a signature-required transporting. In some instances, a rule may define how a value of an object is to be defined based on a predicted likelihood that a user will assert that a transportation error occurred. In some instances, a rule may cancel the object request based on a predicted, likelihood that a user will assert that a transportation error occurred.

The webserver may request user input to approve the object request. For instance, if the response to the object request includes a change in the value of the objects, the user may be directed to approve the updated value before continuing with the object request. The object request may then be processed by passing the requested objects to a transporting entity for transmission to the designated destination address of the object request.

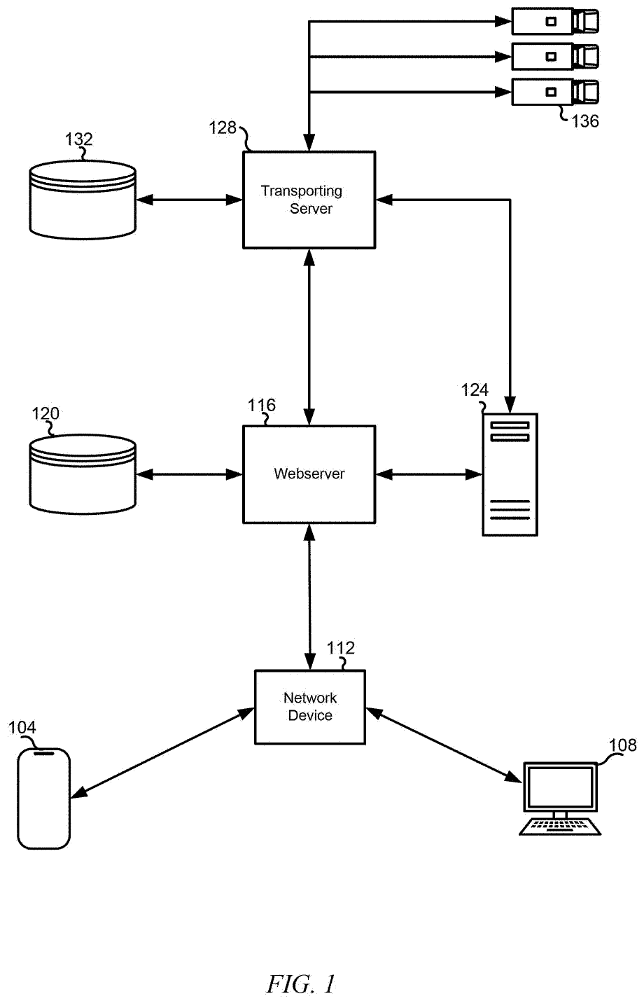

FIG. 1 is a block diagram of system for mitigating transportation errors, according to certain embodiments of the present disclosure. Users may generate object requests in multiple in a variety of protocols. For instance, a user may operate mobile device 104 (e.g., such as network connected phone) or client device 108 (e.g., such as a stationary or mobile computer) to connect to network device 112 (e.g., gateway or the like) to access webserver 116. Webserver 116 may be a security-monitoring computing device that provides a web-service to connected devices (e.g., such as a platform that enables users to browse, select, and obtain objects). Alternatively, the user may operate multiple devices (e.g., requesting one or more objects using mobile device 104 and another one or more objects using client device 108).

Webserver 116 may establish a user session with a user associated with the requesting device. The user session may be store an identification of the user (e.g., such as user login information if it is provided by the user) and an identification of device characteristics of the requesting device (e.g., hardware device type. Internet protocol address, media access control address, operating system type, operating system version, application installed on the device, web browser used to access webserver 116, combinations thereof, or the like). If the user accesses webserver 116 from a second device, webserver may determine that the new device is associated with an already established user session (e.g., by identifying the user of the new device, or characteristics of the new device that are associated with the initial requesting device such as the Internet protocol address, or the like).

The user may operate mobile device 104 and/or client device 108 to request one or more objects for transmission to the user. Webserver 116 may establish an object package (e.g., an object list or network packet) for the user. When the user is ready to complete the object request, the user may provide user-identifying information (e.g., such as a name, username and password, etc.) to webserver 116. Webserver 116 may query database 120 for information associated with the user-identifying information (e.g., such as information provided by the user during a previous object request). For example, database 120 may store identification of previous objects requested, one or more destination addresses, one or more user addresses, request-statement information, transporting errors indicated by the user, or the like. If database 120 returns a null result (e.g., user has not previously requested objects from webserver 116), webserver 116 may request additional user-identifying information such as one or more destination addresses, one or more user addresses, request-statement information, and/or the like. The webserver may store the information (in association with the objects requested by the user) in database 120.

Webserver 116 may query security-monitoring computing device 124 using an identification of the objects requested and the user-identifying information. Security-monitoring computing device 124 (and the computing devices described herein) may include one or more processors coupled to one or more memories. The one or more memories that may store instructions that are executed by the one or more processors (e.g., such as instructions that cause security-monitoring computing device 124 to perform any of the operations described herein). In some instances, security-monitoring computing device 124 may include one or more computers, servers (e.g., that provides services to one or more other devices), distributed computing systems (e.g., such as cloud computing system), or the like. Security-monitoring computing device 124 may be operated independently from webserver 116 and receive object request information from multiple, different webservers. Security-monitoring computing device 124 may receive user-identifying information each time a user initiates a request for objects at a webserver (e.g., including webserver 116 and webservers operated by different entities). Security-monitoring computing device 124 identify a user-object dataset that corresponds to the user and a destination-object dataset that corresponds to the destination address. If the security-monitoring computing device is unable to identify a user-object dataset (e.g., this is the first time the user has requested objects) and/or a destination-object dataset (e.g., this is the first time objects will be transported to the address), security-monitoring computing device 124 may establish new user-object dataset and/or a new destination-object dataset. An object-user dataset may include a hierarchy of metrics that correspond to previous object requests initiated by a same user. The destination-object dataset may include a hierarchy of metrics that correspond to previous object requests in which each previous object request includes a same destination address.

The hierarchy of metrics (of the user-object dataset and/or the destination-object dataset) may correspond to features that are predictive of whether a user is more or less likely to indicate a transporting error. For instance, previously indicated transporting errors may be indicative that the user may be more likely to indicate a future transporting error. The hierarchy of metrics may weight some features higher than others or the combination of features may modify the predictability of other features. For instance, frequency of indicated transporting errors and the time in which each transporting error was indicated may increase the likelihood of transporting errors (e.g., if the transporting errors were indicated recently) or decrease the likelihood of transporting errors (e.g., if the transporting errors were indicated a year or more ago).

In some instances, the user-object datasets and/or destination-object dataset may be augmented using transportation information received directly from transporting server 128 (e.g., an object-storage entity, transporting entity, and/or an entity involved in storing or transporting objects). Transporting server 128 may store information associated with object transportations and particular addresses in database 132. For example, transporting server 128 may store information associated with particular users or addresses that are difficult transportations (e.g., users that indicate transporting errors, addresses that are difficult to identify, addresses that are unsafe to transport to, addresses that are difficult to get to, aggressive animals, etc.). Transporting server 128 may store information associated with particular transportations (e.g., whether the transportation occurred, state of the objects during transportation, etc.). If an incident impacted a particular transportation, transporting server 128 may record information from a transporter 136 (e.g., the truck and/or truck driver that encountered, incident).

The transportation information may be used to authenticate (e.g., corroborate) information stored in a user-object dataset or destination-object dataset. For example, a user-object dataset may include associated with a particular transportation in which the user indicated the objects as being damaged or destroyed during transportation. The transportation information may indicate that a particular transportation was transported successfully and that the package was transported undamaged. The weight associated with the metrics associated with the particular transportation may be adjusted to account for the deviation of the user information from the transportation information. Security-monitoring computing device 124 may augment the user-object dataset and/or destination-object dataset upon receiving the transportation information from transporting server 128.

Security-monitoring computing device 124 may generate a feature vector from the hierarchy of metrics of a user-object dataset, the hierarchy of metrics of a destination-object dataset, and the identification of the objects requested and the user-identifying information received from webserver 116. Security-monitoring computing device 124 may execute a classifier using the feature vector to generate an error metric that corresponds to a prediction indicative of whether the user will indicate an error during this object request. The classifier may be a machine-learning model that generates one or more prediction from the feature vector. The machine-learning model may be a linear classifier (e.g., such as a naive ayes or perceptron), a support vector machine, decision tree, neural network, or the like. The classifier may be a binary or non-binary classifier.

The classifier may be trained using supervised, unsupervised, or semi-supervised learning. For example, security-monitoring computing device 124 may use previous object requests and assign a label to each request that indicates whether the request resulted in a indicated transporting error. Security-monitoring computing device 124 may the train the classifier using the labeled previous object requests. Alternatively, security-monitoring computing device 124 may not label the previous object requests (e.g., unsupervised learning). In those instances, security-monitoring computing device 124 may use classifier or another machine-learning model to identify relationships between the features that are predictive of a user indicate transporting errors.

Once trained, security-monitoring computing device 124 may execute the classifier using the feature vector. The classifier may generate an error metric corresponding to a prediction of whether the user is likely to indicate a transporting error during this object request. The error metric may be Boolean value (e.g., user will or will not indicate a transporting error), an integer (e.g., between 0 and 10 or the like), a percentage, or the like. The error metric may be stored in the user-object dataset and/or destination-object dataset.

In response to receiving the query from webserver 116, security-monitoring computing device 124 may transmit the error metric back to webserver 116. In some instances, security-monitoring computing device 124 may transmit other information in addition to or in place of the error metric. For example, security-monitoring computing device 124 may transmit the user-object dataset and/or the destination-object dataset to the webpage. In other instances, security-monitoring computing device 124 may transmit one or more metrics of the hierarchy of metrics to the webpage based on the user-identifying information. For example, security-monitoring computing device 124 may identify one or more metrics that are contextually similar to the objects being requested by the user. In still yet other instances, security-monitoring computing device 124 may determine a response to the object request based on the user-identifying information, the object requested by the user, and/or previous responses to the object request, which resulted in a reduced likelihood of a user indicating a transporting error. Security-monitoring computing device 124 may then transmit instructions that when received by webserver 116 webpage implement the response to the object request (e.g., by modifying the object request).

Webserver 116 may use the information received from the security-monitoring computing device 124 to modify the object request based on a hierarchy of rules. One or more rules may be defined to determine how to perform object-request processing in view of a prediction of a transporting-error likelihood. The hierarchy of rules may be applied to the object request based on the error metric to generate a response to the object request. In some instances, a rule may indicate that the webserver is to adjust an object value, processing amount, transporting amount, or return policy (e.g., and/or the rule is to specify how such adjustment is to be performed). In some instances, a rule may define how to determine whether a compensation or return policy is to be provided (or what type of compensation or return policy is to be provided if at all) based on the predicted likelihood of an indication of a transporting error. In some instances, a rule may define circumstances under which an object, is to be transported to an alternative location (e.g., different than a destination address entered by the user) based on the predicted likelihood of an indication of a transporting error. For example, a rule may indicate circumstances under which an object is to be transported to a P.O. address. In some instances, a rule may define circumstances under which an object is to be transported with a transporting precaution, such as a signature-required transporting. In some instances, a rule may define how a value of an object is to be defined based on a predicted likelihood that a user will assert that a transportation error occurred. In some instances, a rule may cancel the object request based on a predicted likelihood that a user will assert that a transportation error occurred.

The rules may be applied hierarchically based on the error metric. For example, if two rules are applicable based on an error metric, the higher priority rule may applied in place of the other rules. In some instances, some rules may be applied in addition to other rules based one the error metric and regardless of the hierarchy. For example, a first rule may be marked to execute according to the hierarchy when the error metric is at a first value and in addition to another rule in the hierarchy (e.g., such as the rule adjacent to this rule in the hierarchy) if the error metric is a second value. Application of the rules to the object request enables webserver 116 to generate a response to the object request based, on the error request.

For instance, if the user or destination address associated with the user-identifying information is associated with a high frequency of indicated transporting errors, the security-monitoring computing device may generate a prediction of that the user may be likely to indicate a transporting error. In response, webserver 116 may generate a response by modifying the object request to reduce the likelihood or impact of the object request resulting in a transporting error.

The degree in which the object request may be modified can be based on the information received from security-monitoring computing device 124. For instance, if the error metric is high (e.g., the user recently indicated a number of transporting errors), webserver 116 may increase the value of the object and require that the object be transported to a predetermined location to enable independent verification of the transported state of the objects by the transporting entity. In another instance, if the error metric is medium (e.g., the user indicated a transporting error last month, but has not indicated any transporting errors since), webserver 116 may require that the user obtain transporting protection, such as protection provided by an insurer (i.e., a cover entity). In another instance, if the error metric is low (e.g., the user has not, indicated a transporting error within a predetermined time interval), webserver 116 may not modify the object request or, alternatively, may modify the object request (e.g., by reducing the value or adding an object with a value of zero).

Webserver 116 may transmit a communication to the requesting device (e.g., mobile device 104 and/or client device 108) through network device 112 requesting user input, to confirm the modification to the object request. If the user confirms the modification, then the process may continue in which the user is directed to select a transporting protocol and the objects are transferred to transporting server 128 for the transporter 136. In some instances, if the user declines the modification, webserver 116 may determine an alternative modification. Webserver 116 may present the alternative to the user for selection or present the user with multiple options allowing the user to select the particular modification that is most desirable (e.g., the user generates the response). If the user fails to select a modification or the user declines all possible responses, webserver 116 may determine to proceed with the object request or to terminate the object request.

In some instances, the object may be a network packet that is to be transported from the requesting device (e.g., mobile device 104 and/or client device 108) to another computing device. The security-monitoring computing device 124 can receive a communication from the computing device that includes a first set of characteristics that are based on user interaction with a webpage. The first set of characteristics can include an identification of a user, one or more addresses (e.g., IP addresses) associated with the user, and one or more instances of network-packet acquisition. The security-monitoring computing device 124 generates a user-object dataset for the first set of characteristics that includes a hierarchy of metrics that are predictive of a condition of future network packet acquisitions by the user associated with the first set of characteristics. The security-monitoring computing device 124 can also receive a second set of characteristics associated with a first user-object dataset from the transporting server 128. The second set of characteristics is based on previous instances of network packet transmissions to an IP address of the one or more IP addresses associated with the user. The security-monitoring computing device 124 can modify the hierarchy of metrics of the first user-object dataset based on the second set of characteristics to generate a modified hierarchy of metrics and execute a trained classifier to generate an error metric that is a prediction indicative of a transporting error being indicated for the network packet. The security-monitoring computing device 124 stores the error metric in association with the user-object dataset.

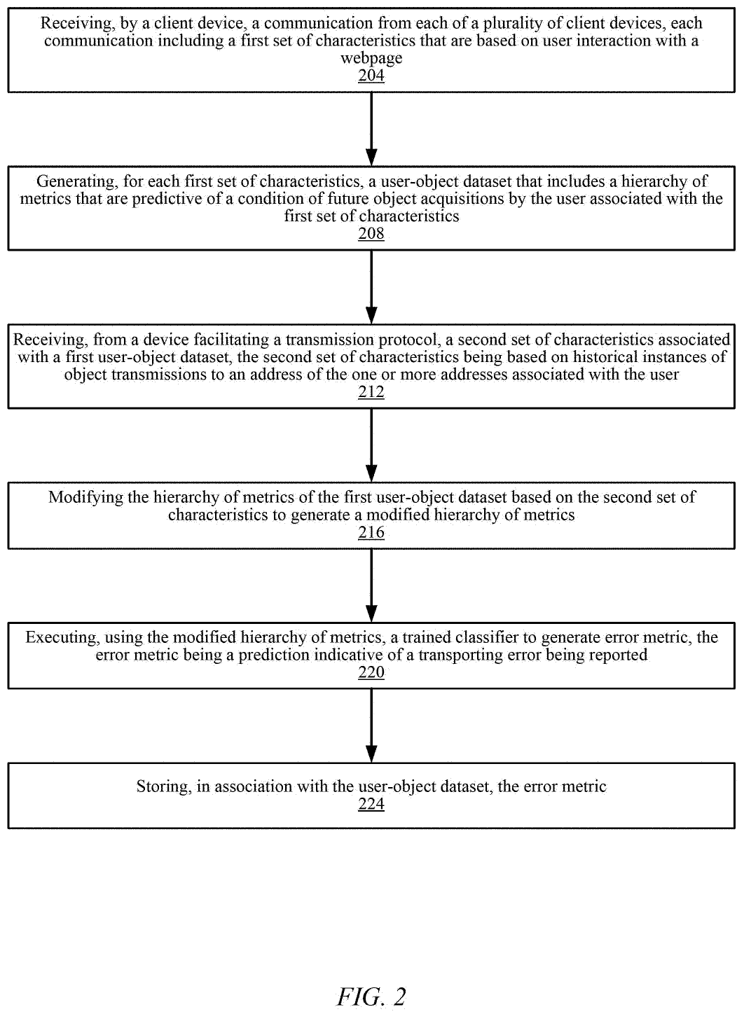

FIG. 2 illustrates a flowchart of a process for processing user-object datasets to predict a likelihood of subsequent transporting errors according to aspects of the present disclosure. At block 204, a security-monitoring computing device receives a communication from each of a plurality of client devices (e.g., webservers operating one or more webpages), each communication including may include a first set of characteristics that are based on user interaction with a webpage. For example, the security-monitoring computing device may receive a first set of characteristics when a user, interacting with the webpage, requests objects. The security-monitoring computing device may receive a characteristics from a multiple different users (each requesting one or more objects) from multiple different webpages (e.g., each providing objects to users). The first set of characteristics may include user-identifying information such as, for example, an identification of a user, residential address of the user, destination address, physical address, email address, request-statement information, information associated with the a device operated by the user to interact with the webpage (e.g., hardware identifier, Internet Protocol address, media access control address, operating system type, operating system version, web-browser type, web-browser version, applications installed on the device, internet service provider, combinations thereof, and the like), and the like.

The first set of characteristics may also include previous-object-request information that may include information associated with a set of discrete requests initiated by the user. Each discrete request may have been for one or more objects. The previous-object-request information may indicate request information, such as, for each request: a number of objects being requested, types of objects being requested, value of objects being requested (e.g., a cumulative value or value of one or more individual objects), an address to which the objects were requested to be transported, and/or a time period during which the objects were requested to be transported. The previous-object-request information may indicate result information, such as whether the user asserted that there was a transportation error (e.g., object damage, late object transportation or no object transportation), whether any user-identified error was determined to have been substantiated, and/or whether an object source compensated for any user-identified error (e.g., and how).

At block 208, the security-monitoring computing device iterates over each first set, of characteristic to generate a user-object dataset for each first set of characteristic. The security-monitoring computing device may process the first set of characteristics by (for example) extracting one or more data-field values from each of a set of data entries and indexing information in accordance with the data-field values. The data-field values by which the first set of characteristics may be indexed may include (for example) a name the user, a transporting address, a user address, a merchant address, and/or the like.

The data-field values may be processed to generate higher level information associated with the user, a group of uses including the user, a destination address, a user address, a given transporting complex address (e.g., such as a multi-tenant building or complex), a given transporting region, and/or a given transporting zip code (e.g., a 5-digit zip code, or a 9-digit zip code). The higher level information may include, for example, a quantity of indicated transporting errors (e.g., a raw number, a frequency, or a percentage of orders for which transporting errors were indicated). In some instances, higher level information may include indices that have the potential to be associated with multiple users (such as roommates or family members). Higher level information may then include (for example) a quantity or identification of users that transported to that address or geographical area (e.g., within a given time period) and/or a distribution error-indicate instances across users that transported to that address (e.g., indicating a number, frequency or proportion of error reports associated with each of multiple users associated with the address or area).

The data-field values may be indexed in multiple ways. For example, suppose that a person is living in an apartment with multiple roommates in an apartment building in a given neighborhood. The person may be associated with an identity of the person, an address of the apartment, an address of the apartment building and an address of the neighborhood. In some instances, data stores are configured to generate data records that are individually associated with each of these indices (e.g., potentially resulting in overlapping data storage). In some instances, links between various types of indices are formed (e.g., such that each transportation record may be associated with two or more of a user identification, address identification, building-address identification, neighborhood identification, and so on).

The security-monitoring computing device generates the user-object dataset using the data-field values extracted from the first set of characteristics.

At block 212, the security-monitoring computing device may receive, from a device facilitating a transportation protocol (e.g., transporting server 128 operated by a transporting entity), a second set of characteristics associated with a first user-object dataset, the second set of characteristics being based on previous instances of object transmissions to an address of the one or more addresses associated with the object-user dataset. The security-monitoring computing device may extract additional data-field values from the second set of characteristics that correspond to information collected and stored by transporting entity. In some instances, the data-field values may include some data-field values that were also included in the first set of characteristics (e.g., due to a change of datasets between the security-monitoring computing device and the device facilitating the transportation protocol). Examples of characteristics that may be included in the second set of characteristics include a set of discrete object requests in which each object request includes, but is not limited to, a destination address, a transporting route (e.g., from a physical object storage center associated with the webpage to the destination address designated by the user), transporting value (e.g., cost), a weight of objects transported, whether the user (or another user) at the destination address accepted or refused the transportation, whether the user indicated a transporting error (e.g., damaged, destroyed, and/or not received objects), whether the address is associated with multiple instances of transporting errors, whether the device facilitating the transportation protocol includes a indicated of damage to the objects or packaging during transmission, whether the objects were indicated as transported, whether a user indicated a transporting error, condition of the address, difficulty of the address to identify or locate, safety of transporting to the address, interactions with users at the address, interactions with users in a same neighborhood as the address, transporting error indications in a predetermined geographical area surrounding the destination address (e.g., such as not transported objects, object theft, etc.), and the like.

In some instances, the security-monitoring computing device may receive a second set of characteristics each time a user requests objects that are transported to the user. In other instances, the computing device may receive a second set of characteristics that corresponds to multiple instances in which the user ordered objects that were transported to the user.

In some instances, the client device may receive the a third set of characteristics from another remote computing device such as, but not limited to, a cover entity, a home owners association, a residential management office, or the like. The client device may augment the second set of characteristics with extracted data-field values from the third set of characteristics.

At block 216, the security-monitoring computing device modifies the hierarchy of metrics of the first user-object dataset based on the second set of characteristics to generate a modified hierarchy of metrics. In some instances, the security-monitoring computing device may merge the first user-object dataset with data-field values extracted from the second set of characteristics. For example, the data-field values extracted from the second set of characteristics may indicate a frequency in which transporting errors are indicated at the address. Since the first object dataset is indexed to the user, the first user-object may not include transporting errors associated with other user at the destination address or nearby address. The data-field values extracted from the second set of characteristics may augment the first user-object dataset to incorporate the newly extracted data-field values of the second set of characteristics.

At block 220, the security-monitoring computing device executes a trained classifier (e.g., a machine-learning model) to generate an error metric using the modified hierarchy of metrics of the user-object dataset. The error metric may be a prediction indicative of a transporting error being indicated during a subsequent object request (e.g., the next object request initiated by the user). The error metric may be a Boolean value or an alphanumerical value (e.g., between 0 and 1, a percentage, etc.) indicating a likelihood that a user will indicate a transporting error during a subsequent object request. In some instances, the security-monitoring computing device may also generate a response to a subsequent object request based on the error metric. The response may be based on an application of a hierarchy of rules based on the error metric that modify an object request to reduce the likelihood that a transporting error may be indicated or reduce the impact if a transporting error is indicated. A transporting error may cause an object source to consume limited resources to correct the error (e.g., processing resources of computing devices and/or computing devices to manage inventories and transport new objects, time to execute the corrective action, transporting value and the replaced objects, etc.), So, modifying the object request to reduce the likelihood that a transporting error may be indicated or reduce the impact if a transporting error is indicated may reduce resources consumed by the object source.

In some instances, a rule may indicate that the webserver is to adjust an object value, processing amount, transporting amount, or return policy (e.g., and/or the vile is to specify how such adjustment is to be performed). In some instances, a rule may define how to determine whether a compensation or return policy is to be provided (or what type of compensation or return policy is to be provided if at all) based on the predicted likelihood of an indication of a transporting error. In some instances, a rule may define circumstances under which an object is to be transported to an alternative location (e.g., different than a destination address entered by the user) based on the predicted likelihood of an indication of a transporting error. For example, a rule may indicate circumstances under which an object is to be transported to a P.O. address. In some instances, a rule may define circumstances under which an object is to be transported with a transporting precaution, such as a signature-required transporting. In some instances, a rule may define how a value of an object is to be defined based on a predicted likelihood that a user will assert that a transportation error occurred. In some instances, a rule may cancel the object request based on a predicted likelihood that a user will assert that a transportation error occurred.

The rules may be applied hierarchically based on the error metric. For example, if two rules are applicable based on an error metric, the higher priority rule may applied in place of the other rules. In some instances, some rules may be applied in addition to other rules based one the error metric and regardless of the hierarchy. For example, a first rule may be marked to execute according to the hierarchy when the error metric is at a first value and in addition to another rule in the hierarchy (e.g., such as the rule adjacent to this rule in the hierarchy) if the error metric is a second value. Application of the rules to the object request enables webserver 116 to generate a response to the object request based, on the error request.

At block 224, the security-monitoring computing device stores the error metric in association with the user-object dataset. The security-monitoring computing device may receive a query that includes an identification of objects requested and user-identifying information. The security-monitoring computing device may identify the user-object dataset that corresponds to the user-identifying information of the query and transmit the error metric to the requesting device. Alternatively, the security-monitoring computing device may execute the classifier to update the error metric (e.g., using the identification of objects requested and user-identifying information in addition to the user-object dataset) and transmit the updated error metric to the requesting device.

In some examples, a webserver may operate a webpage that enables a user to determine if the user is authorized to initiate a future object request. For instance, a particular user may input some user-identifying information and (optionally) an identification of one or more objects into a field of the webpage. The webserver may transmit a pre-authorization request to the security-monitoring computing device. In response, the security-monitoring computing device may retrieve a user-object dataset that corresponds to the particular user. For example, the security-monitoring computing device may extract data-field values from the user-identifying information and match one or more of the extracted data-field values to corresponding values in user-object datasets until a the matching user-object dataset is identified.

The security-monitoring computing device may then generate a pre-authorization result that provides an indication of whether the particular user is authorized to initiate a future object request. The security-monitoring computing device may generate the pre-authorization result based on the error metric of the particular user-object dataset. In some instances, the security-monitoring computing device may use information in the pre-authorization request to generate an updated error metric. In those instances, the security-monitoring computing device may also synchronize the particular user-object dataset with data from one or more remote computing devices (e.g., such as a device associated with a transporting entity, a device associated with the particular user, a device associated with a cover entity, a device associated with a residential or commercial management office, or the like) to ensure the particular-object dataset includes the most recent information associated with the particular user or a destination address (e.g., that is associated with the particular user). The security-monitoring computing device may then execute the classifier using the user-data object and the information in the pre-authorization request to generate an updated error metric. If the pre-authorization request includes an identification of the one or more objects for which pre-authorization is sought, the security-monitoring computing device may also use the identification of the one or more objects when executing the classifier.

The pre-authorization result may provide an indication that the particular user is authorized to initiate a future object request or that the particular user is not authorized to initiate a future object request. For example, if the error metric is greater than a threshold the pre-authorization result may provide an indication that the particular user is not authorized to initiate a future object request. If the error metric is less than the threshold the pre-authorization result may provide an indication that the particular user is authorized to initiate a future object request.

In some instances, when the error metric is greater than the threshold, the per-authorization result may include a response to the pre-authorization request. For instance, the security-monitoring computing device may generate the response by applying the hierarchy of rules to the combined pre-authorization result and error metric. The response may include an authorization for the user to initiate a future object-request that subject to one or more conditions. The conditions may correspond a modification to the future object request (e.g., such as a value adjustment to the one or more objects, a requirement for transporting protection, a predetermined destination address, etc. as similarly described above).

In other instances, the particular user may interact with the webpage to identify one or more modifications that the user is willing to apply to a future object request so that the user may be authorized to initiate the future object request. The webserver may determine if the one or more modifications would change a pre-authorization result of not being authorized (e.g., to thereby authorize the user to initiate the future object request). Alternatively, the webserver may transmit the identification of the one or more modifications to the security-monitoring computing device. The security-monitoring computing device may determine whether the one or more one or more modifications would change the pre-authorization result. The particular user may interact with the webpage to select various modifications to derive a set of modifications that would be both acceptable to the particular user and would authorize the particular user to initiate the future object request.

The webpage may be operated by the particular user (e.g., an end user such as a consumer, agent of the object source, an agent of the transporting entity, or the like). For instance, the particular user may operate the webpage (e.g., as described above). Alternatively, an entity of the object source may operate the webpage to determine if a user would be authorized for a particular object request before the object request is initiated. In that instances, the entity of the object source may derive the set of modifications to the future object request if the user ends up not being authorized for the future object request.

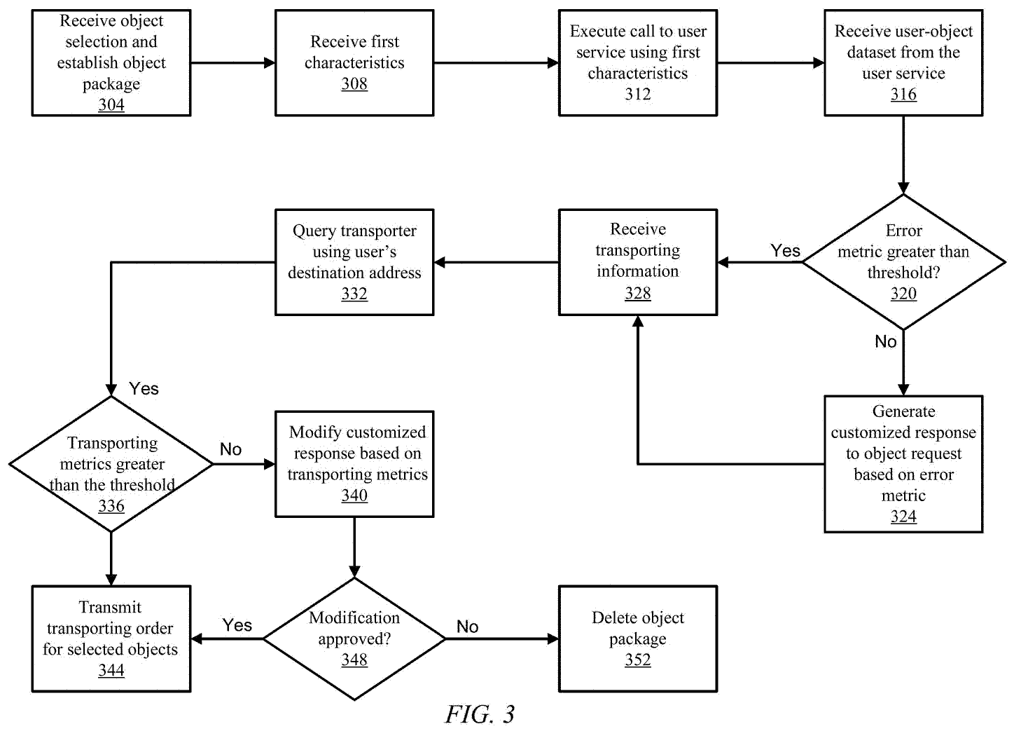

FIG. 3 illustrates a block diagram of a process for modifying object requests according to aspects of the present disclosure. At block 304, a webserver (e.g., executed by a computing device and) operating a webpage may receive a selection of objects from a user. The objects may be data that is to be transmitted from the computing device to a computing device of the user as network packets. The webserver may then establish an object package (e.g., an object list, object order, or network packet) that includes the selected objects. At block 308, the webserver may receive first characteristics from the user that correspond to user-identifying information. Examples of characteristics included in the first set of characteristics include, but are not limited to, a name of the user, an identifier of the user (e.g., username, handle, account or profile identifier, etc.), destination address, residential address, request-statement address, request-statement information, properties of a user device used to access the webpage (e.g., media access control address, Internet protocol address, operating system, browser, internee service provider, or the like), an identifier of a webpage account of the user, an identification of the one or more objects requested, timestamp associated with the request or selection of objects, transporting entity used to transport the objects, transporting details (e.g., type of transporting selected), whether the user requested a return or compensation, whether the user indicated an error with the transportation of the object (e.g., an indication that the object was damaged, destroyed, or not received), and the like.

At block 312, the webserver executes an application programming interface (API) call to a security-monitoring computing device to user service of a security-monitoring computing device. The call may include the one or more objects of the object package and first set of characteristics.

At block 316, the webserver receives, in response to the call to the security-monitoring computing device, a user-object dataset that includes information associated with the user, instances of discrete (previous) object requests, and an error metric. The error metric may be generated using a classifier (e.g., trained machine-learning model) executed by the security-monitoring computing device. For instance, the classifier may use the user-object dataset as input to generate the error metric. Alternatively, the classifier may use the user-object dataset, the identification of the selected objects, and the user-identifying information to generate the error metric. The error metric may represent a prediction of a likelihood (e.g., probability) that the user will indicate a transporting error during the current object request.

At block 320, the webserver determines if the error metric is greater than a threshold. If the error metric is greater than the threshold, webserver moves to block 324 in which the webserver generates a response to the object request by modifying the object package. For instance, the object package may be modified by applying a hierarchy of rules. Examples of rules, include, but are not limited to terminating the object request, adjusting an object value, adjusting a processing amount, adjusting a transporting amount, adjusting a return policy (e.g., and/or the rule is to specify how such adjustment is to be performed), determining whether a compensation or return policy is to be provided (or what type of compensation or return policy is to be provided if at all), defining circumstances under which an object is to be transported to an alternative location (e.g., different than a destination address entered by the user), indicating circumstances under which an object is to be transported to a P.O. address, defines circumstances under which an object is to be transported with a transporting precaution (such as a signature-required transporting), defining how a value of an object is to be defined, defining when an object request is to be canceled (e.g., due to a high likelihood the user will indicate a transporting error), combinations thereof, or the like.

At block 328 (e.g., if the error metric was not greater than the threshold or after the response to the object requests is generated), the webserver receives transportation information if transportation information was not included in block 308. The transportation information may include a destination address, selection of a transporting entity, selection of a transportation protocol (e.g., type of transporting such as overnight, priority, regular transporting, etc.) or the like.

At block 332, the webserver queries a transporting computing device (e.g., a computing device operated by the selected transporting entity) for transportation information associated with the user and/or the destination address. The transporting computing device may return the requesting transportation information (e.g., such as destination-object dataset and/or an error metric associated with and stored within the destination-object dataset). The transportation information may include, but is not limited to, previous instances of object transmissions to the selected destination address (e.g., with each instance of an object transmission including a destination address, whether a transporting error was indicated, an identification of the user that received the objects, demographic data of the user or geographical area of the destination address, indicated transporting areas in the geographical area of the destination address, and/or the like). The transportation information may also include information associated with transporting the objects of the current object request (e.g., such as a transporting route, a transporting value, whether a signature is required upon receipt, or the like).

At block 336, the webserver extracts data-field values from the transportation information to determine if the transportation information includes transporting metrics (e.g., an error metric of the destination-object dataset) that are greater than threshold. In some instance, the webserver may use the transporting metrics to augment the error metric. In other instances, the webserver may transmit the transportation information to the security-monitoring computing device with instructions to execute the classifier using the transportation information. The security-monitoring computing device may return an updated error metric based on information from the transporting security-monitoring computing device. In still yet other instances, the webserver processes the transporting metrics to derive an error metric. If the transporting metrics are greater than the threshold, the process continues to block 340, where the response may be modified on the new information. The modification to the response may include application of the same hierarchy of rules that generated the response to the object request. The modification may include additional modifications to the object request, a reduction in the previously applied modifications, or elimination the previously applied modifications.

At block 348, the webserver requests user input from the user to approve the response to the object request. If the user does not approve the response to the object request, the webserver may provide one or more alternative responses for user selection. If the user still does not approve the alternative responses, the process moves to block 352 where the object package may be deleted and the process terminates.

At block 344 (e.g., if the transporting metrics were not greater than the threshold or if the user approved a response to the object request), the object package may be transmitted to the selected transporting computing device to facilitate the transfer of the selected object to the address of the user subject to the conditions of the response. For instance, if the response indicates that transporting protection is to be applied, the webserver may request additional resources to obtain the protection or request that the user to obtain proof of protection prior to transmitting the object package to the transporting computing device. The process then terminates.

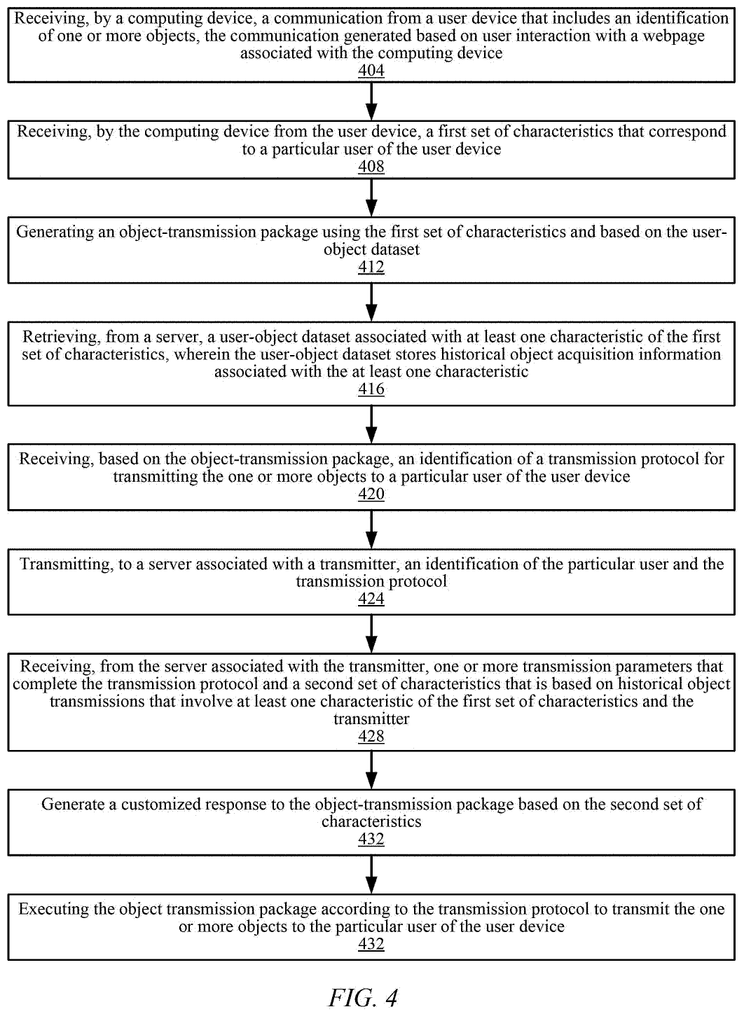

FIG. 4 depicts an example flowchart of a process for generating a response to an object request, according to certain aspects of the present disclosure. At block 404, a client device receives a communication from a user device that includes an identification of one or more objects. The communication may be generated based on user interaction with a webpage associated with the client device. In some instances, the communication may correspond to a user selecting one or more objects from a webserver operating the webpage. In other instances, the communication may correspond to a pre-authorization request for a future object request.

At block 408, the client device receives a first set of characteristics that correspond to a particular user of the user device. For example, the first set of characteristics may be user-identifying information such as, but are not limited to, a name of the user, an identifier of the user (e.g., username, handle, account or profile identifier, etc.), destination address, residential address, request-statement address, request-statement information, properties of a user device used to access the webpage (e.g., media access control address, Internet protocol address, operating system, browser, internet service provider, or the like), an identifier of a webpage account of the user, and the like.

At block 412, the client device generates an object package using the first set of characteristics and based on the user-object dataset.

At block 416, the client device retrieves, from a client device, a user-object dataset associated with at least one characteristic of the first set of characteristics. The user-object dataset may store previous object-acquisition information associated with the at least one characteristic. For example, the computing device may match a username, user's name, and/or a user identifier (such as universally unique identifier associated with the user) provided by the client device to a corresponding username, user's name, and/or a user identifier stored in the user-object dataset. In another example, the computing device may match an address or IP address provided by the user-identifying information to an address or IP address stored in a user-object dataset. The computing device may identify the requested user-object from a database that stores user-object datasets associated with multiple users.

The user-object dataset includes information associated with previous instances of object requests initiated by the user. The user-object dataset may include a hierarchy of metrics that may be predictive of the likelihood that that a future object request initiated by the user will result in a transporting error (e.g., damaged object upon transportation, a destroyed object upon transportation, a not received object, a stolen object, a compensation, a replacement, etc.). For example, the hierarchy of metrics may correspond to features selected or derived from the user-identifying information and/or the one or more previous instances of object acquisitions.

At block 420, the client device receiving, an identification of a transportation protocol for transmitting the one or more objects to a particular user of the user device. The transportation protocol may indicate a mechanism by which the selected objects are to be transmitted to an address selected by the user. For instance, the transportation protocol may include a transporting entity, a transporting type (e.g., regular transportation, expedite or priority transportation, overnight transportation, etc.), or the like.

At block 424, the client device transmits to a computing device associated with a transmitter (e.g., the transporting entity), an identification of the particular user and the transportation protocol.

At block 428, the client device receives, from the computing device associated with the transmitter, one or more transmission parameters that are to be included in the transportation protocol and a second set of characteristics that is based on previous object transmissions that involve at least one characteristic of the first set of characteristics and the transmitter. The one or more transmission parameters may include a confirmation that the transporting entity can transmit the requested objects to the destination address of the user, an indication of a transporting process, a tracking number, a transporting value, and/or the like. For instance, the client device may use the transmission parameters to update the object package with the transportation information selected by the user and transporting value such that the object package includes the total value owed by the user.

The second set of characteristics may include information associated with the destination address such as a destination-object dataset. The destination-object dataset may include previous transportation information associated with the destination address. The destination-object dataset can include for each identified of previous instances in which the transporting entity transmitted objects to an address associated with the destination address, an identification of the objects transported to the destination address, transporting errors indicated at the destination address, transporting errors indicated in a geographical area surrounding the destination address, demographic information of the user or the geographical area, a condition of the destination address, difficulty of the address to identify or locate, safety issues of transporting objects to the address, interactions with users at the address, interactions with users in a same neighborhood as the address, indicated object theft at the destination address or at addresses in the area, combinations thereof, and the like.

In some instances, the client device may receive the a third set of characteristics from another remote computing device such as, but not limited to, a cover entity, a home owners association, a residential management office, or the like. The client device may augment the second set of characteristics with extracted data-field values from the third set of characteristics.

At block 432, the client device generates a response to the object package that includes a modification to the object package based on the user-object dataset and/or the second set of characteristics. For example, if the user frequently indicates transporting errors or transporting errors are indicated at the destination address, the object package may be modified to reduce the likelihood of transporting errors or to mitigate impact of the transporting errors. The client device may apply a hierarchy of rules to the object package to generate the response. Examples of rules, include, but are not limited to terminating the object request, adjusting an object value, adjusting a processing amount, adjusting a transporting amount, adjusting a return policy (e.g., and/or the rule is to specify how such adjustment is to be performed), determining whether a compensation or return policy is to be provided (or what type of compensation or return policy is to be provided if at all), defining circumstances under which an object is to be transported to an alternative location (e.g., different than a destination address entered by the user), indicating circumstances under which an object is to be transported to a P.O. address, defines circumstances under which an object is to be transported with a transporting precaution (such as a signature-required transporting), defining how a value of an object is to be defined, defining when an object request is to be canceled (e.g., due to a high likelihood the user will indicate a transporting error), combinations thereof, or the like.

At block 432, the client device executes the modified object package according to the transportation protocol to transmit the one or more objects to the particular user of the user device. Executing the modified object-transmission may include transmitting a transporting order to the transmitter. The transporting order may indicate a quantity of objects to transmit to the user, an origin location of the objects for pickup, a destination address, the user-identifying information, combinations thereof, and the like.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

1. A method comprising:
receiving, by a security-monitoring computing device, a communication from each of a plurality of client devices, each communication including a first set of characteristics that are based on user interaction with a network document, wherein each first set of characteristics includes:
an identification of a user;
one or more addresses associated with the user; and
one or more instances of an object acquisition;
generating, for each first set of characteristics, a user-object dataset that includes a hierarchy of metrics that are predictive of a condition of future object acquisitions by the user associated with the first set of characteristics; and
receiving, from a device facilitating a transportation protocol, a second set of characteristics associated with a first user-object dataset, the second set of characteristics being based on previous instances of object transportations to an address of the one or more addresses associated with the user;
modifying the hierarchy of metrics of the first user-object dataset based on the second set of characteristics to generate a modified hierarchy of metrics;
executing, using the modified hierarchy of metrics, a trained classifier to generate an error metric, the error metric being a prediction indicative of a transporting error being indicated; and
storing, in association with the user-object dataset, the error metric.

2. The method of claim 1, further comprising:
receiving, by the security-monitoring computing device, a query from a client device of the plurality of client devices, the query including a third set of characteristics;
retrieving a particular user-object dataset based on the third set of characteristics; and
transmitting the error metric of the particular user-object dataset.

3. The method of claim 2, wherein the error metric is a likelihood that the user will indicate the transporting error during a subsequent object request.

4. The method of claim 1, further comprising:
receiving, by the security-monitoring computing device from a client device, a pre-authorization request associated with a particular user;
retrieving a particular user-object dataset associated with the particular user; and
transmitting, to the client device, a pre-authorization result based on the error metric of the particular user-object dataset, the pre-authorization result providing an indication of whether the particular user is authorized to initiate a future object request.

5. The method of claim 4, wherein the pre-authorization result includes one or more modifications for application to a future object request initiated by the particular user.

6. The method of claim 1, wherein the user-object dataset includes one or more instances of previous object requests by the user.

7. The method of claim 1, wherein the user-object dataset includes one or more instances of an indicated transporting error, wherein the transporting error includes a damaged, destroyed, or not-received object

8. The method of claim 1, further comprising:
generating instructions for reducing the error metric based on the user-object dataset, the instructions including a modification to a subsequent object request.

9. The method of claim 1, wherein the second set of characteristics including an indicated transporting error associated with another user.

10. The method of claim 1, wherein the second set of characteristics including an indicated transporting error associated with an address near an address of the one or more addresses.

11. A method comprising:
receiving, by a client device, a communication from a user device that includes an identification of one or more objects, the communication generated based on user interaction with a network document associated with the client device;
receiving, by the client device from the user device, a first set of characteristics that correspond to a particular user of the user device;
generating an object package using the first set of characteristics;
retrieving, from a security-monitoring computing device, a user-object dataset associated with at least one characteristic of the first set of characteristics, wherein the user-object dataset stores previous object acquisition information associated with the at least one characteristic;
receiving, based on the object package, an identification of a transportation protocol for transmitting the one or more objects to the particular user of the user device;
transmitting, to the security-monitoring computing device associated with a transmitter, an identification of the particular user and the transportation protocol;
receiving, from the security-monitoring computing device associated with the transmitter:
one or more transportation parameters that are to be included in the transportation protocol; and
a second set, of characteristics that is based on previous object transportations that involve at least one characteristic of the first set of characteristics and the transmitter;
generating a response to the object package based on the second set of characteristics, the response including a modification to the object package; and
executing the object package according to the transportation protocol to transmit the one or more objects to the particular user of the user device.

12. The method of claim 11, wherein the modification includes changing a value of the one or more objects.

13. The method of claim 11, wherein the modification includes changing a destination address of the one or more objects to an address associated with the transmitter.

14. The method of claim 11, further comprising:
modifying, in response to receiving the user-object dataset, the object package based on an error metric of the user-object dataset.

15. The method of claim 11, wherein the user-object dataset includes an identification of one or more instances in which the particular user indicated a transporting error.

16. The method of claim 11, wherein the second set of characteristics includes an identification of one or more instances in which a transporting error was indicated at a destination address.

17. The method of claim 11, wherein the second set of characteristics includes an identification of one or more instances in which a transporting error was indicated at an address with a predetermined distance from a destination address.

18. The method of claim 11, wherein the first set of characteristics includes a destination address for the one or more objects.

19. A system comprising:
one or more processors and
a non-transitory computer-readable media that includes instructions that when executed by the one or more processors, cause the one or more processors to perform a set of actions including:
receiving, by a security-monitoring computing device, a communication from each of a plurality of client devices, each communication including a first set of characteristics that are based on user interaction with a network document, wherein each first set of characteristics includes:
an identification of a user;
one or more addresses associated with the user; and
one or more instances of an object acquisition;
generating, for each first set of characteristics, a user-object dataset that includes a hierarchy of metrics that are predictive of a condition of future object acquisitions by the user associated with the first set of characteristics; and
receiving, from a device facilitating a transportation protocol, a second set of characteristics associated with a first user-object dataset, the second set of characteristics being based on previous instances of object transportations to an address of the one or more addresses associated with the user;
modifying the hierarchy of metrics of the first user-object dataset based on the second set of characteristics to generate a modified hierarchy of metrics;
executing, using the modified hierarchy of metrics, a trained classifier to generate an error metric, the error metric being a prediction indicative of a transporting error being indicated; and
storing, in association with the user-object dataset, the error metric.

20. A non-transitory computer-readable media that includes instructions that when executed by one or more processors, cause the one or more processors to perform a set of actions including:
receiving, by a security-monitoring computing device, a communication from each of a plurality of client devices, each communication including a first set of characteristics that are based on user interaction with a network document, wherein each first set of characteristics includes:
an identification of a user;
one or more addresses associated with the user; and
one or more instances of an object acquisition;
generating, for each first set of characteristics, a user-object dataset that includes a hierarchy of metrics that are predictive of a condition of future object acquisitions by the user associated with the first set of characteristics; and
receiving, from a device facilitating a transportation protocol, a second set of characteristics associated with a first user-object dataset, the second set of characteristics being based on previous instances of object transportations to an address of the one or more addresses associated with the user;
modifying the hierarchy of metrics of the first user-object dataset based on the second set of characteristics to generate a modified hierarchy of metrics;
executing, using the modified hierarchy of metrics, a trained classifier to generate an error metric, the error metric being a prediction indicative of a transporting error being indicated; and
storing, in association with the user-object dataset, the error metric.
